(19) United States
(12) Patent Application Publication
(10) Pub. No.: US 2003/0146620 A1
(43) Pub. Date: Aug. 7, 2003

(54) Swivel drop ear elbow fitting

(76) Inventors: Scott C. Young, Coldwater, MI (US); Richard R. Allman, Fremont, IN (US); Thomas O. Mumaw, Marshall, MI (US); Gregory A. Reitsma, Marshall, MI (US)

Correspondence Address: SCOTT C. YOUNG ET AL., 695 Kenmoor, S. E., Post Office Box 2567, Grand Rapids, MI, 49501, US

(21) Appl. No.: 10/061,699

(22) Filed: Feb. 1, 2002

(51) Int. Cl. F16L 43/00

(52) U.S. Cl. 285/179

(57) ABSTRACT

A swivel drop ear elbow fitting includes a threaded nut, a retaining ring, and a hollow elbow adapter. The threaded nut includes a plurality of integrated attachment ears located along an external periphery of the threaded nut. An outer surface of the first portion of the elbow adapter is shaped to receive the retaining ring, which retains the threaded nut on the first portion of the elbow adapter, while allowing the hollow elbow adapter to rotate with respect to the threaded nut.

### BACKGROUND OF THE INVENTION

The present invention is generally directed to an elbow fitting and, more specifically, to a swivel drop ear elbow fitting.

Today, a variety of elbow fittings have been utilized in commercial and residential applications. For example, elbow fittings have been used in shower installations in modular homes and recreational vehicles. Typically, in such applications, a specialized type of elbow fitting, with mounting flanges that are integrally formed along the elbow fitting, have been utilized. The mounting flanges have included apertures, which receive fasteners, for fastening the elbow fitting between wall studs. One section of the elbow fitting has generally included tapered threads that receive one end of an angled showerhead pipe. The other end of showerhead pipe has extended into the shower area and has been threaded to receive a showerhead.

A second section of the elbow fitting has typically been formed at a right angle to the first section of the elbow fitting. In general, when installing the threaded showerhead pipe into the first section of the elbow fitting an installer has utilized a plumbing tape or plumbing dope to prevent water leakage at the joint. Due to the fact that the showerhead pipe is angled it has frequently been necessary to loosen the showerhead pipe with respect to the elbow fitting, to achieve proper showerhead pipe alignment. Unfortunately, loosening the showerhead pipe has frequently resulted in leakage at the joint. Further, utilization of elbow fittings whose constituent parts are fixed with respect to each other has also resulted in installment alignment difficulties with respect to a supply line.

What is needed is an elbow fitting that can be readily fixed with respect to a support structure that also mitigates installation alignment problems, while at the same time providing a reliable leakproof connection between the elbow fitting and associated connecting pipes.

### SUMMARY OF THE INVENTION

An embodiment of the present invention is directed to a swivel drop ear elbow fitting that includes a threaded nut, a retaining ring and a hollow elbow adapter. The threaded nut includes a plurality of integrated attachment ears or an integrated mounting ring located along an external periphery of the threaded nut. Each of the attachment ears, when implemented includes an aperture for receiving a fastener for securing the threaded nut to a stationary support. Likewise, the mounting ring when implemented includes a plurality of mounting holes. The hollow elbow adapter includes a first portion centrally positioned with respect to a first axis and a second portion centrally positioned with respect to a second axis, where the second axis is not colinear with the first axis. An outer surface of the first portion of the elbow adapter is shaped to receive the retaining ring, which retains the threaded nut on the first portion of the elbow adapter, while allowing the hollow elbow adapter to rotate with respect to the threaded nut.

In another embodiment, the first axis is substantially orthogonal with respect to the second axis. In yet another embodiment, the first axis forms an obtuse angle with respect to the second axis. In still another embodiment, the plurality of integrated attachment ears includes three attachment ears that are equally spaced along the external periphery of the threaded nut. In one embodiment, the retaining ring is a grooveless retaining ring. In another embodiment, an outer surface of the second portion of the hollow elbow adapter includes a plurality of axially spaced ribs. In yet another embodiment, the swivel drop ear elbow fitting includes a seal that is a cone-shaped seat or a gasket made of an elastomeric material or rubber with an inner diameter sized to receive the first portion of the hollow elbow adapter and an outer diameter sized to substantially eliminate fluid leakage between an external fitting (e.g., a showerhead pipe) that is threadingly received by the threaded nut. In still another embodiment, the threads of the threaded nut are straight threads.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a top view of a swivel drop ear elbow fitting, according to an embodiment of the present invention;

FIG. 2 is an end view of the elbow fitting of FIG. 1;

FIG. 3 is a cross-sectional view, along the line III-III, of the elbow fitting of FIG. 1;

FIG. 4 is an end view of the elbow fitting of FIG. 1 from an end opposite the end shown in FIG. 2;

FIG. 5 is a bottom perspective view of the elbow fitting of FIG. 1;

FIG. 6 is a bottom view of the elbow fitting of FIG. 1; and

FIG. 7 is a side view of the elbow fitting of FIG. 1.

### DETAILED DESCRIPTION OF PREFERRED EMBODIMENTS

According to the present invention, a swivel drop ear elbow fitting includes a threaded nut, a retaining ring and a hollow elbow adapter. In one embodiment, the threaded nut includes a plurality of integrated attachment ears located along an external periphery of the threaded nut, with each of the attachments ear including an aperture for receiving a fastener for securing the threaded nut to a stationary support (e.g., a horizontal board mounted between two upright wall studs). The threaded nut may be made of a variety of materials, e.g., brass, plastic or a plastic with a metal threaded insert.

The elbow adapter includes a first portion centrally positioned with respect to a first axis and a second portion centrally positioned with respect to a second axis. The second axis is not colinear (e.g., substantially orthogonal (eight-five to ninety-five degrees) or at an obtuse angle) with the first axis and an outer surface of the first portion of the elbow adapter is shaped to receive the retaining ring, which retains the threaded nut on the first portion of the elbow adapter, while allowing the elbow adapter to rotate (e.g., swivel) with respect to the threaded nut. The elbow adapter may also be made of a variety of materials (e.g., brass) and a suitable material for the retaining ring is stainless steel or steel.

According to one embodiment of the present invention, a seal between an external fitting (e.g., the showerhead pipe or showerhead pipe fitting) and the elbow fitting is achieved with a seal that has an inner diameter sized to receive the first portion of the elbow adapter and an outer diameter sized to substantially eliminate fluid leakage between the external fitting and the elbow fitting. The seal may be, for example, a cone-shaped seat or gasket made of a rubber or an elastomeric material (e.g., nitrile or santoprene). Alternatively, the seal may take the form of an o-ring that is held captive in a base of the threaded nut.

In a disclosed embodiment, the retaining ring is a grooveless retaining ring (e.g., a grooveless retaining ring manufactured and made commercially available by Tinnerman of Eaton Engineered Fasteners (Part No. T99220-SS-120-576)). However, it should be appreciated by one of ordinary skill in the art that the threaded nut can be retained on the first portion of the hollow elbow adapter by a snap ring that fits into a groove in an outer surface of the first portion of the hollow elbow adapter.

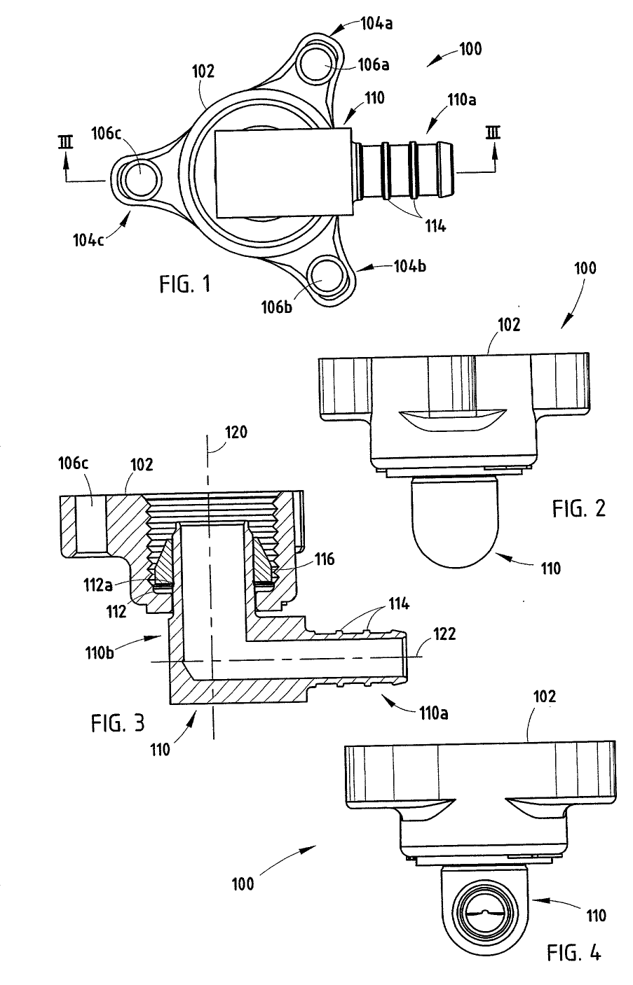

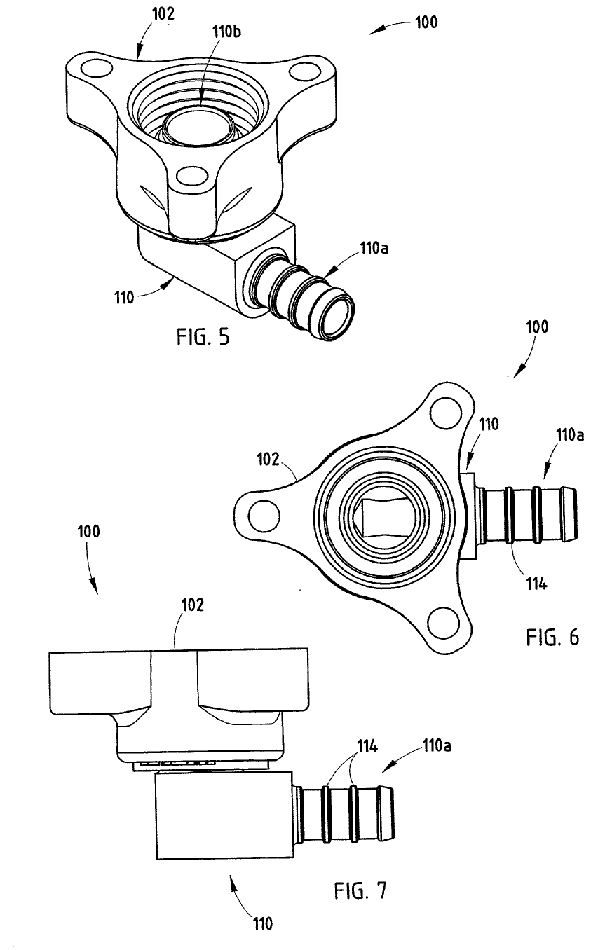

FIGS. 1-7 depict various views of a swivel drop ear elbow fitting 100, according to an embodiment of the present invention. With reference to FIG. 1, the fitting 100 includes a threaded nut 102 and a hollow elbow adapter 110. The threaded nut 102 includes a plurality of integrated attachment ears 104a, 104b and 104c, which include apertures 106a, 106b and 106c, respectively, for receiving fasteners (e.g., wood screws) for securing the threaded nut 102 to a stationary support (e.g., a board horizontally positioned between two upright wall studs). Alternatively, the threaded nut may include a mounting ring, with multiple mounting holes, that extends around the external periphery of the threaded nut.

With reference to FIG. 3, a cross-sectional view of the fitting 100 of FIG. 1 along the lines III-III is depicted. As is shown in FIG. 3, a retaining ring 112 is in contact with an outer surface of a first portion 110b of the hollow elbow adapter 110. A seal 116 is positioned on the first portion 110b of the hollow elbow adapter 110 that extends beyond the retaining ring 112. As is shown in FIG. 3, the retaining ring includes a flange 112a that extends along the inner periphery of the retaining ring 112. The retaining ring 112 is constructed such that the flange 112a digs into the outer surface of the first portion 110b to counteract a force which would separate the threaded nut 102 and the hollow elbow adapter 110. A second portion 110a of the elbow adapter 110 includes a plurality of axially aligned ribs 114, which are utilized to retain a plastic tube that is slid over the outer surface of the second portion 110a. In practice, a clamp, e.g., a crimped metallic ring or ferrule, is utilized to retain the plastic tube on the second portion 110a of the hollow elbow adapter 110.

It should be appreciated that the second portion 110a of the elbow adapter 110 can be configured in various forms, e.g., configured as a sweat fitting of an appropriate size such that it can be soldered to a copper supply line, a PVC fitting, a threaded male fitting, etc. Alternatively, the second portion 110a of the hollow elbow adapter 110 may be threaded to receive an inlet pipe.

Accordingly, a swivel drop ear elbow fitting has been described which seals the connection point, between a showerhead pipe or showerhead pipe fitting and a hollow elbow adapter, with a cone-shaped seat made of an elastomeric material. In many applications, such a seal is preferable to those relying on a tapered thread with plumbing tape or plumbing dope to effect a leakproof joint. Further, the swivel drop ear elbow fitting alleviates alignment problems in a number of ways. Additionally, an elbow fitting according to the present invention provides a nut that can be locked into place to facilitate easier replacement of the showerhead pipe should the need arise. Such an elbow fitting is particularly advantageous in the manufactured housing market, as the elbow fitting is generally quick and easy to install, thus, saving time and money, as well as generally improving quality. When straight threads are utilized in the threaded nut, instead of tapered threads, greater engagement between the showerhead pipe (i.e., arm) and swivel drop ear elbow fitting can be achieved, without the need for plumbing tape or dope.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A swivel drop ear elbow fitting, comprising:
a threaded nut including one of a plurality of integrated attachment ears and an integrated mounting ring located along an external periphery of the threaded nut, wherein each of the attachment ears when implemented includes an aperture for receiving a fastener for securing the threaded nut to a stationary support, and wherein the mounting ring when implemented includes a plurality of mounting holes;
a retaining ring; and
a hollow elbow adapter including a first portion centrally positioned with respect to a first axis and a second portion centrally positioned with respect to a second axis, wherein the second axis is not colinear with the first axis, and wherein an outer surface of the first portion of the elbow adapter is shaped to receive the retaining ring which retains the threaded nut on the first portion of the hollow elbow adapter while allowing the hollow elbow adapter to rotate with respect to the threaded nut.

2. The swivel drop ear elbow fitting of claim 1, wherein the first axis is substantially orthogonal with respect to the second axis.

3. The swivel drop ear elbow fitting of claim 1, wherein the first axis forms an obtuse angle with respect to the second axis.

4. The swivel drop ear elbow fitting of claim 1, wherein the plurality of integrated attachment ears includes three attachment ears that are equally spaced along the external periphery of the threaded nut.

5. The swivel drop ear elbow fitting of claim 1, wherein the retaining ring is a grooveless retaining ring.

6. The swivel drop ear elbow fitting of claim 1, wherein an outer surface of the second portion of the hollow elbow adapter includes a plurality of axially spaced ribs.

7. The swivel drop ear elbow fitting of claim 1, further including:
a seal with an inner diameter sized to receive the first portion of the hollow elbow adapter and an outer diameter sized to substantially eliminate fluid leakage between an external fitting that is threadingly received by the threaded nut.

8. The swivel drop ear elbow fitting of claim 7, wherein the seal is one of a cone-shaped seat and a gasket made of one of an elastomeric material and rubber.

9. The swivel drop ear elbow fitting of claim 1, wherein threads of the threaded nut are straight threads.

10. A swivel drop ear elbow fitting, comprising:
a threaded nut including a plurality of integrated attachment ears located along an external periphery of the threaded nut, wherein each of the attachment ears includes an aperture for receiving a fastener for securing the threaded nut to a stationary support;
a retaining ring;
a hollow elbow adapter including a first portion centrally positioned with respect to a first axis and a second portion centrally positioned with respect to a second axis, wherein the second axis is colinear with the first axis, and wherein an outer surface of the first portion of the elbow adapter is shaped to receive the retaining ring which retains the threaded nut on the first portion of the hollow elbow adapter while allowing the hollow elbow adapter to rotate with respect to the threaded nut; and
a seal with an inner diameter sized to receive the first portion of the hollow elbow adapter and an outer diameter sized to substantially eliminate fluid leakage between an external fitting that is threadingly received by the threaded nut.

11. The swivel drop ear elbow fitting of claim 10, wherein the first axis is substantially orthogonal with respect to the second axis.

12. The swivel drop ear elbow fitting of claim 10, wherein the first axis forms an obtuse angle with respect to the second axis.

13. The swivel drop ear elbow fitting of claim 10, wherein the plurality of integrated attachment ears includes three attachment ears that are equally spaced along the external periphery of the threaded nut.

14. The swivel drop ear elbow fitting of claim 10, wherein the retaining ring is a grooveless retaining ring.

15. The swivel drop ear elbow fitting of claim 10, wherein an outer surface of the second portion of the hollow elbow adapter includes a plurality of axially spaced ribs.

16. The swivel drop ear elbow fitting of claim 10, wherein the seal is one of a cone-shaped seat and a gasket made of one of an elastomeric material and rubber.

17. A swivel drop ear elbow fitting, comprising:
a threaded nut including a plurality of integrated attachment ears located along an external periphery of the threaded nut, wherein each of the attachment ears includes an aperture for receiving a fastener for securing the threaded nut to a stationary support, and wherein threads of the threaded nut are straight threads;
a retaining ring;
a hollow elbow adapter including a first portion centrally positioned with respect to a first axis and a second portion centrally positioned with respect to a second axis, wherein the second axis forms an obtuse angle with respect to the first axis, and wherein an outer surface of the first portion of the elbow adapter is shaped to receive the retaining ring which retains the threaded nut on the first portion of the hollow elbow adapter while allowing the hollow elbow adapter to rotate with respect to the threaded nut; and
a cone-shaped seat made of one of an elastomeric material and rubber with an inner diameter sized to receive the first portion of the hollow elbow adapter and an outer diameter sized to substantially eliminate fluid leakage between an external fitting that is threadingly received by the threaded nut.

18. The swivel drop ear elbow fitting of claim 17, wherein the plurality of integrated attachment ears includes three attachment ears that are equally spaced along the external periphery of the threaded nut.

19. The swivel drop ear elbow fitting of claim 17, wherein the retaining ring is a grooveless retaining ring.

20. The swivel drop ear elbow fitting of claim 17, wherein an outer surface of the second portion of the hollow elbow adapter includes a plurality of axially spaced ribs.
